(19) United States
(12) Patent Application Publication
(10) Pub. No.: US 2004/0213696 A1
(43) Pub. Date: Oct. 28, 2004

(54) UV disinfection for turbid liquids

(76) Inventor: Lewis J. Daly, Fayetteville, NY (US)

Correspondence Address: Owen D. Marjama, WALL MARJAMA & BILINSKI LLP, Suite 400, 101 South Salina Street, Syracuse, NY, 13202, US

(21) Appl. No.: 10/771,051

(22) Filed: Feb. 3, 2004

Related U.S. Application Data
(60) Provisional application No. 60/444,556, filed on Feb. 3, 2003.

(51) Int. Cl. C02F 1/32

(52) U.S. Cl. 422/24; 261/75

(57) ABSTRACT

A method for disinfecting turbid liquids which includes reducing liquid opacity by diffusing the turbid liquid and exposing the liquid to a source of UV radiation for a time sufficient to disinfect and/or sterilize the liquid. The diffusion may be accomplished by aerating, agitation, misting or atomizing the turbid water.

### BACKGROUND OF THE INVENTION

The present invention relates in general to the use of ultraviolet (UV) radiation and more specifically to the use of UV radiation in the disinfection of turbid and dirty liquids such as water.

The use of UV radiation has long been known in the disinfection and sterilization of air and water. The following patents are typical of the state of the art with respect to illustrating the use of UV radiation in treating air and liquids.

U.S. Pat. No. 4,990,313 teaches the use of a low frequency ultraviolet device mounted inline in an air return system of an air conditioning unit to resupply return air. The ultraviolet emissions are directed at the cooling coil and drain pan and function to destroy cooling coil and drain pan bacterial accumulations and the growth of mold spores and other airborne diseases, pollen and pollutants resulting in the purification of the return air.

U.S. Pat. No. 5,558,158 teaches an air handling unit in which a blower draws and discharges air through highly reflective internally coated chambers and where the air is bathed with direct and reflected ultraviolet light which functions to prohibit the growth of mold, spores, bacteria and other organisms and microorganisms and allergens.

U.S. Pat. Nos. 4,983,307 and 5,266,280 are directed to sterilizing fluids through the use of reactors which function to sterilize and/or sanitize fluids such as turbid organic laden water, gases and solvents.

U.S. Pat. No. 6,372,186 is directed to a germicidal lamp for harsh environments which uses UV radiation to disinfect and sterilize in an outdoor installation on heating, ventilating and/or air conditioning systems.

A problem in the prior art which has not been effectively addressed relates to the use of UV radiation in the disinfection and sterilization of turbid, dirty or unclear liquids such as water. Because of the nature and the opacity of turbid liquids, UV rays are attenuated by the turbid liquid such that only a small amount of water volume adjacent to the UV source is actually penetrated by the UV radiation and thereby effectively treated.

It can therefore be seen that there is a need in the field for a UV system which can efficiently and effectively treat turbid fluid and liquids such as water.

### SUMMARY OF THE INVENTION

It is therefore an objective of the present invention to overcome the problems of the prior art described above.

It is a further object of the present invention to provide a method of treating turbid fluids which utilizes a gas stream with a fluid flow to allow greater illumination and penetration by UV radiation.

It is a further object of the present invention to provide a UV disinfection system for turbid liquids, in which the turbid fluids being treated is dispersed with an air stream which enhances the disinfection process.

It is a further object of the present invention to provide a system for UV disinfection of turbid liquids which utilizes an enclosed cartridge and closed system wherein the cartridge includes within it a source of UV radiation.

The present invention is directed to a method of UV disinfection of turbid liquids in which the liquid to be treated is aerated, agitated, misted, atomized or otherwise broken up or diffused into a lower density active air/liquid mixture which allows for a greater penetration of the disinfecting UV illumination. This method results in a more efficient and complete disinfection or sterilization of the liquid particles and also results in the disinfection of the air which takes place at the time of treatment of the fluid.

In one specific embodiment of the present invention, a sealed cartridge which internally contains a source of UV radiation is fed the aerated or otherwise treated turbid fluid in the form of more translucent air/liquid mixture which has been separated by the aeration/agitation method of the present invention which will be described herein in greater detail.

### BRIEF DESCRIPTION OF THE DRAWINGS

For a further understanding of these and other objects of the invention, reference will be made to the following detailed description of the invention which is to be read in connection with the accompanying drawings, wherein:

FIG. 1 is a schematic side view of one embodiment illustrating the system of the present invention.

FIG. 2 is a schematic side view of a second embodiment illustrating the system of the present invention.

### DETAILED DESCRIPTION OF THE INVENTION

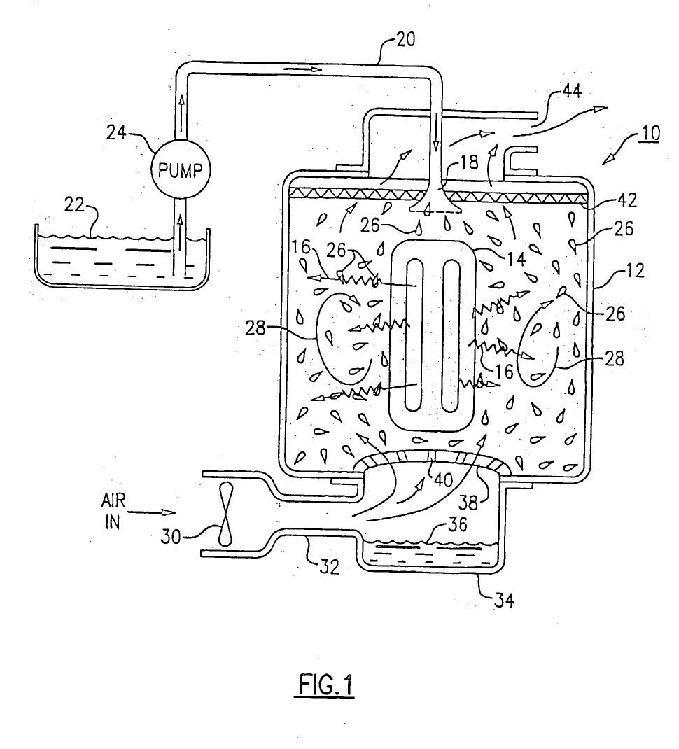

One embodiment of the present invention is illustrated by FIG. 1 of the drawings. In this embodiment a UV disinfection system 10 for turbid liquid is in the form of a sealed cartridge 12 which contains a source of UV illumination 14 with the illumination being illustrated by arrows 16. The turbid water 22 to be treated is pumped through conduit 20 by pump 24 through a nozzle or shower head 18 into the sealed cartridge 12 in the form of water droplets 26. The water droplets 26 are supported by an air stream which is generated by fan 30 and conduit 32 which passes air through openings 40 and a diffuser plate 38 at the bottom of cartridge 12. The water droplets are agitated and recirculated as illustrated by curved arrows 28 by the air stream which suspends the water droplets 26 in the UV illumination field where the droplets are sanitized and/or disinfected. The treated droplets pass through perforated diffuser plate 38 into a water collector 34. The air passes through an upper condenser plate 42 and out of the cartridge through port 44. In this system, the UV field of radiation will illuminate a greater volume of the cartridge and therefore a greater percentage of the liquid droplets due to the fact that the droplets have less attenuation of the UV radiation than if an all liquid volume where being treated by the same radiation.

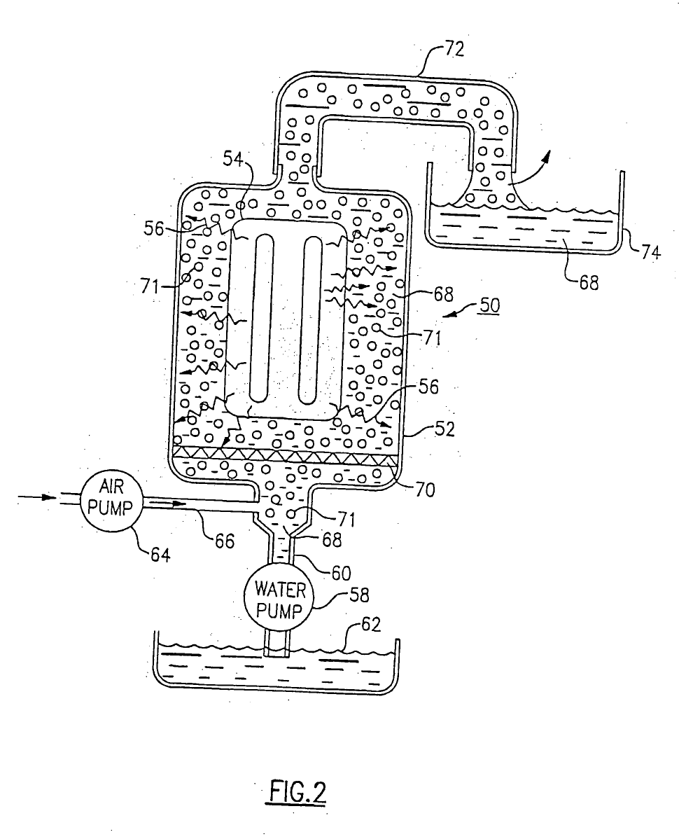

A second embodiment of the present invention is illustrated in FIG. 2. The UV disinfection system 50 for turbid liquids includes a sealed cartridge 52 which contains a source of UV radiation 54 which generates radiation illustrated by arrows 56. In this embodiment, turbid waste water to be treated 62 is contained in a sump and transported by pump 58 through conduit 60 and mixed with an air stream generated by air pump 64 through conduit 66 which provides multiple air bubbles 71 which with water 68 pass through diffuser plate 70 near the bottom of the cartridge. By introducing air bubbles the effective optic density of the turbid liquid is reduced, allowing the UV radiation to penetrate deeper into, and through the liquid to be decontaminated. Water and air flow velocities are adjusted so as to reduce the liquid opacity around the UV source 54 and allow more complete UV penetration for increased water sterilization and/or decontamination. The carrier air stream is also cleaned as it passes through the UV illumination field. Droplets of treated water pass through or flow through conduit 72 connected to the top portion of the cartridge with the air being released at the end of said conduit and the treated water 68 being collected in container 74.

While the present invention has been particularly shown and described with reference to the preferred mode as illustrated in the drawing, it will be understood by one skilled in the art that various changes in detail may be effected therein without departing from the spirit and scope of the invention as defined by the claims.

We claim:

1. A method of treating turbid water which comprises aerating a source of turbid water with an air stream to diffuse, dilute and reduce the opacity of the water concentration through the aeration process, and simultaneously exposing said aerated water to a source of UV radiation for a time sufficient to sanitize and/or sterilize said turbid water.

2. A method for disinfecting turbid liquids which comprises:
(a) providing an enclosed sealed cartridge which has an air inlet and turbid water inlet at one end thereof,
(b) providing an air stream sufficient to aerate and move said water adjacent a source of UV radiation contained within said cartridge,
(c) continuing said process for a time sufficient to disinfect said water, and
(d) recovering said treated water in a water collection means.

3. A method of treating turbid water which comprises diffusing a stream of turbid water to form water droplets and agitating and suspending said water droplets in an air stream and simultaneously exposing said water droplets to a source of UV for a time sufficient to sanitize and/or sterilize said water.

4. A method for disinfecting turbid liquids which comprises:
(a) providing an enclosed sealed cartridge which has an air inlet and turbid water inlet,
(b) diffusing said turbid water within said chamber to the form of water droplets,
(c) providing an air stream from said air inlet sufficient to form, support, and agitate droplets of water adjacent a source of UV radiation contained within said cartridge,
(d) continuing said process for a time sufficient to disinfect said water droplets, and
(e) recovering the sterilized droplets of water in a water collection means.
